(19) United States
(12) Patent Application Publication
(10) Pub. No.: US 2015/0134087 A1
(43) Pub. Date: May 14, 2015

(54) SYSTEM TO ENABLE/DISABLE WEAPONS

(71) Applicant: Mercury Automation, North Wales, PA (US)

(72) Inventor: Daniel J. PALMER, North Wales, PA (US)

(21) Appl. No.: 14/532,111

(22) Filed: Nov. 4, 2014

Related U.S. Application Data
(60) Provisional application No. 61/901,898, filed on Nov. 8, 2013.

(51) Int. Cl. F41A 17/06; G05B 15/02

(52) U.S. Cl. CPC F41A 17/063; G05B 15/02
USPC 700/90

(57) ABSTRACT

A weapon control system comprising; a weapon; and a weapon controller in communication with the weapon, wherein said weapon controller is configured to receive data and determine whether to enable or disable the weapon.

### CROSS-REFERENCE TO RELATED APPLICATIONS

The present application claims the benefit of U.S. Provisional Application No. 61/901,898, filed Nov. 8, 2013, which is incorporated herein by reference in its entirety.

### BACKGROUND OF THE TECHNOLOGY

The present invention relates to the field of weapons and the ability to enable and/or disable them based on various factors, such as their global position. This can be, but not limited to, the position of the weapon at the time the weapon is deployed or activated.

There are numerous weapons systems in production and deployed throughout the world. Nations may seek to deploy numerous weapons alongside their armed forces. Nations have also sold and/or given numerous weapons to allies throughout the world. In some situations, those weapons could end up in the hands of enemies or terrorists. It is desirable to nations supplying the weapons to avoid the possibility of these weapons being used against them or their allies.

The ability to deploy weapons which cannot be used outside of a certain range of global positions would allow such nations to provide weapons to allies without the fear that these weapons could fall into the wrong hands and then be used against the nation or its allies.

### BRIEF SUMMARY OF THE TECHNOLOGY

One aspect of the present technology is to overcome the shortcomings of the prior art, e.g. to control the operability of weapons based on location.

Another aspect of the present technology is directed to a system to enable or disable a weapon or weapons based on various inputs detected or provided.

Another aspect of the present technology is directed to a method for receiving information and enabling or disabling a weapon based on the received information.

Another aspect of the present technology is directed to a weapon control system. The weapon control system may comprise: a weapon; and a weapon controller in communication with the weapon, wherein said weapon controller is configured to receive data and determine whether to enable or disable the weapon.

In examples, (a) the weapon control system may comprise an enabling device, said enabling device may be in communication with said weapon controller to provide data to the weapon controller, and said data may be used by the weapon controller to determine whether to enable or disable the weapon, (b) said enabling device and said weapon controller may be directly connected to one another to facilitate communication, (c) said enabling device and said weapon controller may be located separately and may be in wired communication, (d) said enabling device and said weapon controller may be located separately and may be in wireless communication, (e) said weapon controller may comprise a sensor and said data may comprise location data, (f) said location data may be provided by a global positioning satellite to the sensor, (g) said weapon controller may comprise a weapon interface to enable and disable the weapon, and/or (h) said weapon controller may be integral with said weapon.

Another aspect of the present technology may be directed to a method for enabling and disabling a weapon with a weapon controller. The method may comprise: receiving first data through a sensor of the weapon controller; comparing said first data with second data in a processing unit of the weapon controller, said second data stored in a memory device of the weapon controller; determining with said processing unit whether to enable or disable the weapon based on comparing said first data with said second data; and enabling or disabling said weapon with a weapon interface of the weapon controller.

In examples, (a) the method may comprise: connecting an enabling device to said weapon controller; and providing third data from said enabling device to said weapon controller, and determining with said processing unit whether to enable or disable the weapon may further comprise processing of said third data, (b) said first data may be location data transmitted by a global positioning satellite and said second data may be coordinates defining an authorized zone of use, and/or (c) the weapon may be enabled when the weapon is determined to be located in the authorized zone of use based on comparing said first data and said second data.

Of course, portions of the aspects/examples may form sub-aspects/sub-examples of the present technology. Also, various ones of the sub-aspects/sub-examples and/or aspects/examples may be combined in various manners and also constitute additional aspects/examples or sub-aspects/sub-examples of the present technology.

Other features of the technology will be apparent from consideration of the information contained in the following detailed description, abstract, drawings and claims.

### BRIEF DESCRIPTION OF THE DRAWINGS

The present technology is illustrated by way of example, and not by way of limitation, in the figures of the accompanying drawings, in which like reference numerals refer to similar elements including:

FIG. 1A shows a user with a location enabled/disabled weapon according to an example of the present technology.

FIG. 1B shows a location enabled/disabled weapon according to an example of the present technology.

FIG. 2A shows a user with a location enabled/disabled weapon according to another example of the present technology.

FIG. 2B shows a location enabled/disabled weapon according to another example of the present technology.

FIG. 3A shows a user with a location enabled/disabled weapon according to another example of the present technology.

FIG. 3B shows a location enabled/disabled weapon according to another example of the present technology.

FIG. 4A shows a user with a location enabled/disabled weapon according to another example of the present technology.

FIG. 4B shows a location enabled/disabled weapon according to another example of the present technology.

FIG. 5A shows a schematic of a weapon controller according to an example of the present technology.

FIG. 5B shows a schematic of an enabling device according to an example of the present technology.

### DETAILED DESCRIPTION

Before the present technology is described in further detail, it is to be understood that the technology is not limited to the particular examples described herein, which may vary. It is also to be understood that the terminology used in this disclosure is for the purpose of describing only the particular examples discussed herein, and is not intended to be limiting.

The following description is provided in relation to several examples which may share common characteristics and features. It is to be understood that one or more features of any one example may be combinable with one or more features of the other examples. In addition, any single feature or combination of features in any of the examples may constitute additional examples.

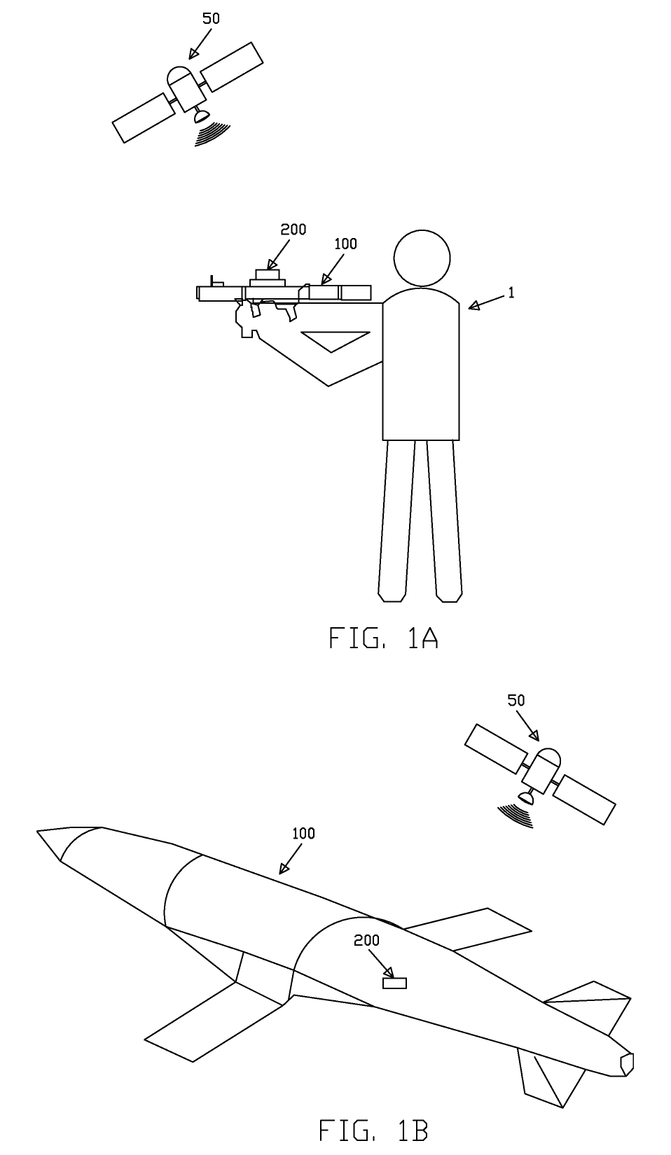

FIG. 1A shows a user 1 with a handheld weapon 100 according to an example of the present technology. The handheld weapon 100 may include a weapon controller 200, which will be described in greater detail below. The weapon controller 200 may determine whether to enable or disable the handheld weapon 100. The weapon controller 200 may enable or disable the handheld weapon 100 based on location data determined from a satellite 50 of a global positioning system (GPS). The weapon controller 200 may be enabled or disabled based on other data, as will be described further below.

FIG. 1B shows another weapon 100 that includes the weapon controller 200. The weapon 100 may not be handheld (i.e., manually operated by a user 1. The weapon 100 shown in FIG. 1B may be a missile, free-falling bomb (guided or unguided), artillery shell, mine, rocket etc. It should be understood that the weapon 100 enabled or disabled by the weapon controller 200 may be any of a variety of weapons known to those skilled in the art. The weapon controller 200 described herein may be advantageous for use with weapons that are more easily concealed and transported, such that those types of weapons would be more susceptible to captured by an unintended user (e.g., an enemy or terrorist).

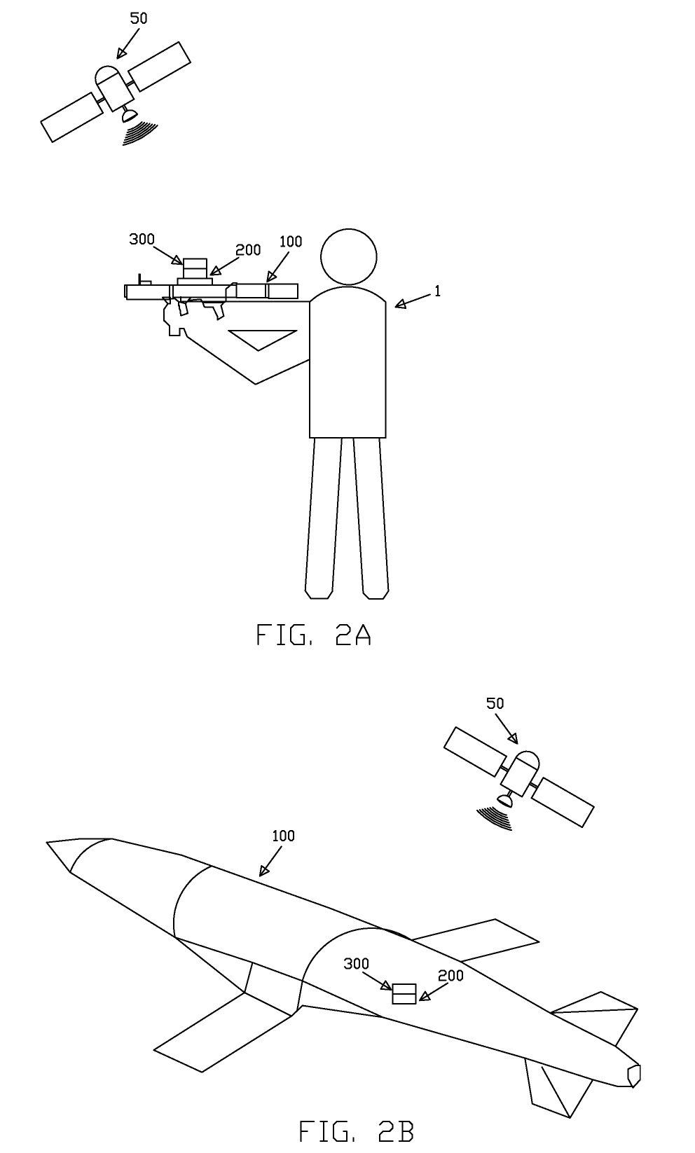

FIG. 2A shows the user 1 with the handheld weapon 100 equipped with the weapon controller 200 and having an enabling device 300 installed thereon. The enabling device 300, also described in greater detail below, may communicate with the weapon controller 200 to facilitate enablement or disablement of the weapon 100. For example, the weapon 100 may be manufactured integrally with the weapon controller 200 to facilitate mass production. However, the enabling device 300 may be required by the weapon controller 200 to enable or disable the weapon 100.

FIG. 2A also shows the satellite 50 providing location data to the weapon controller 200 for enablement or disablement of the weapon. It is envisioned that the location-based control facilitated by the satellite 50 may be additional or alternative to the enabling device 300. For example, the enabling device 300 may be necessary, but not sufficient, to enable the weapon 100, such that even with the enabling device installed the weapon is not enabled until the weapon controller 200 detects that the weapon is at a location where it is authorized for use. Likewise, the weapon 100 may be located where it is authorized to be used, however, without the enabling device 300 the weapon controller 200 will not enable the weapon. Such an arrangement may provide an additional safeguard against unauthorized use that may be beneficial in a scenario such as on a battlefield where authorized and unauthorized users may be in the same authorized location, but only authorized users are provided with the enabling device 300 to enable the weapon 100.

FIG. 2B depicts another weapon 100 (e.g., a missile) that incorporates the weapon controller 200 and the enabling device 300 as an additional safeguard against unauthorized use. Enablement and disablement of the weapon 100 shown in FIG. 2B may be similar to that of the weapon shown in FIG. 2A, except that the weapon is different, In either case, the enabling device 300 may be required to arm the weapon 100 and the weapon controller 200 may additionally require that the weapon be located in an authorized zone before enablement.

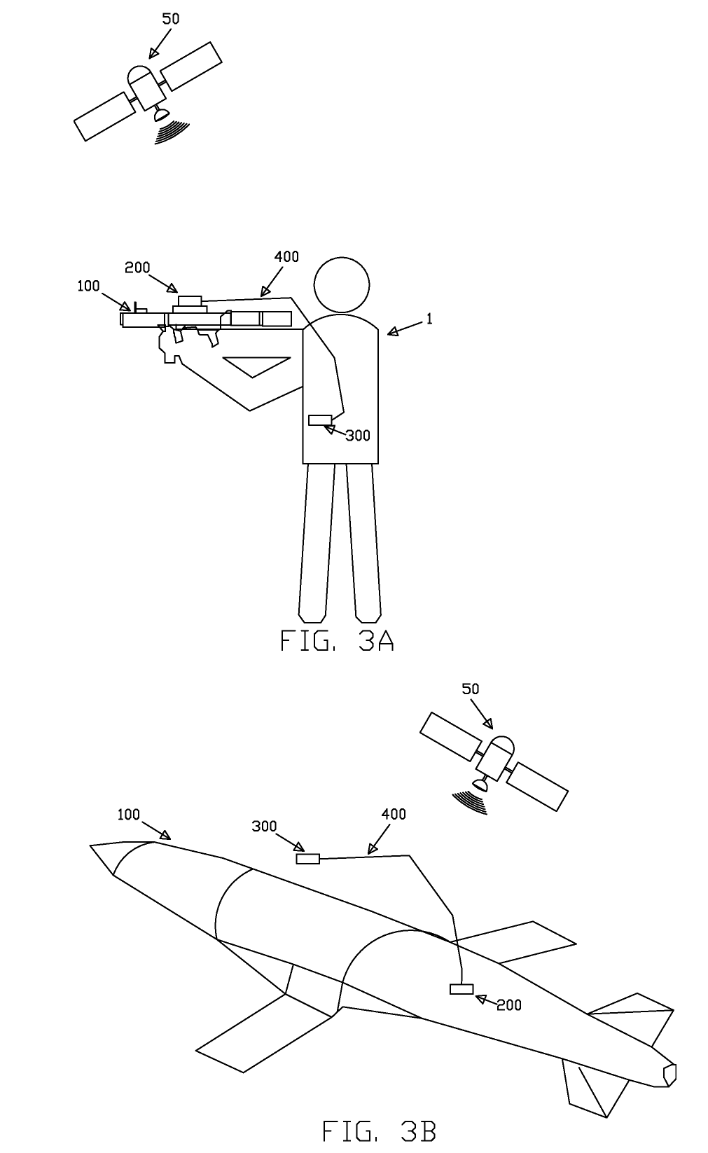

FIGS. 3A and 3B show similar respective arrangements to FIGS. 2A and 2B, The examples shown in FIGS. 3A and 3B, however, require a connection 400 to facilitate communication between the enabling device 300 and the weapon controller 200. The connection 400 may be any type of wired connection know in the art. For example, universal serial bus (USB) or Ethernet connections may be used. USB and Ethernet connections may be desirable for use as the connection 400 because they facilitate the transmission of data such that the enabling device 300 may communicate back and forth with the weapon controller 200.

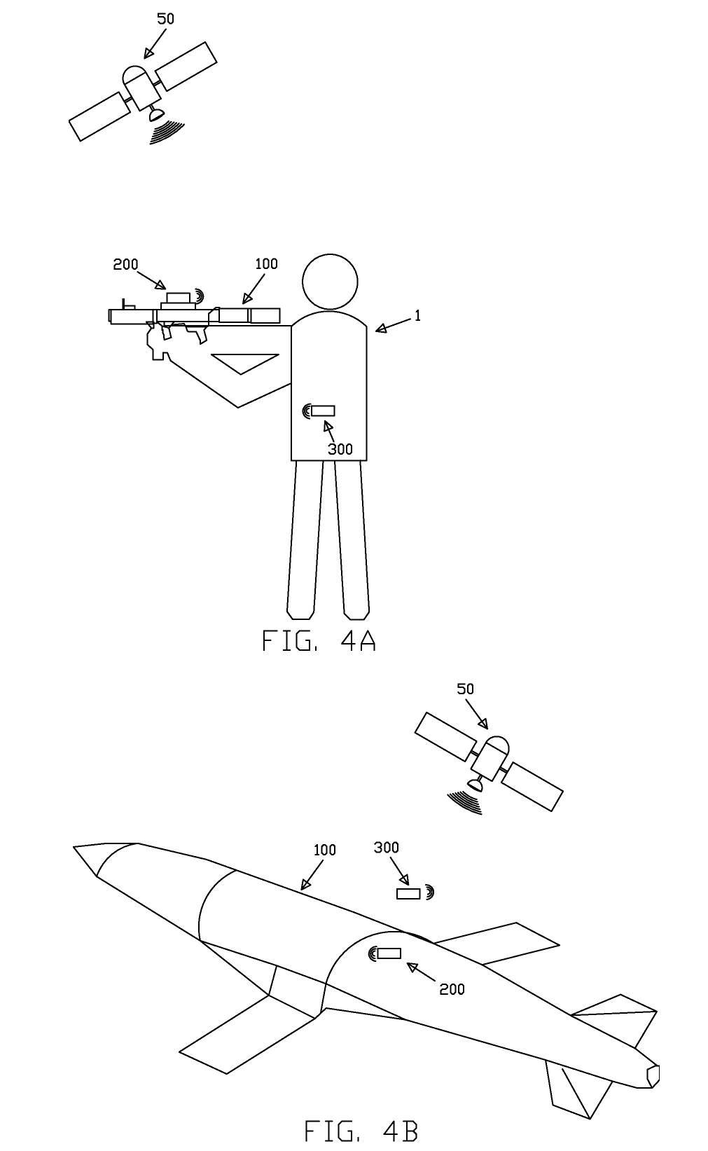

FIGS. 4A and 4B show another arrangement similar to that shown in FIGS. 3A and 3B. FIGS. 4A and 4B, however, show examples of the weapon controller 200 and the enabling device 300 being in wireless communication. By not linking the weapon controller 200 and the enabling device 300 through the connection 400, more freedom for placement of the enabling device relative to the weapon controller may be possible. Wireless communication between the weapon controller 200 and the enabling device 300 may be facilitated by 900 MHz and/or 2.4 GHz signals. Other wireless communication protocols such as Bluetooth® and near field communication (NFC) are also envisioned.

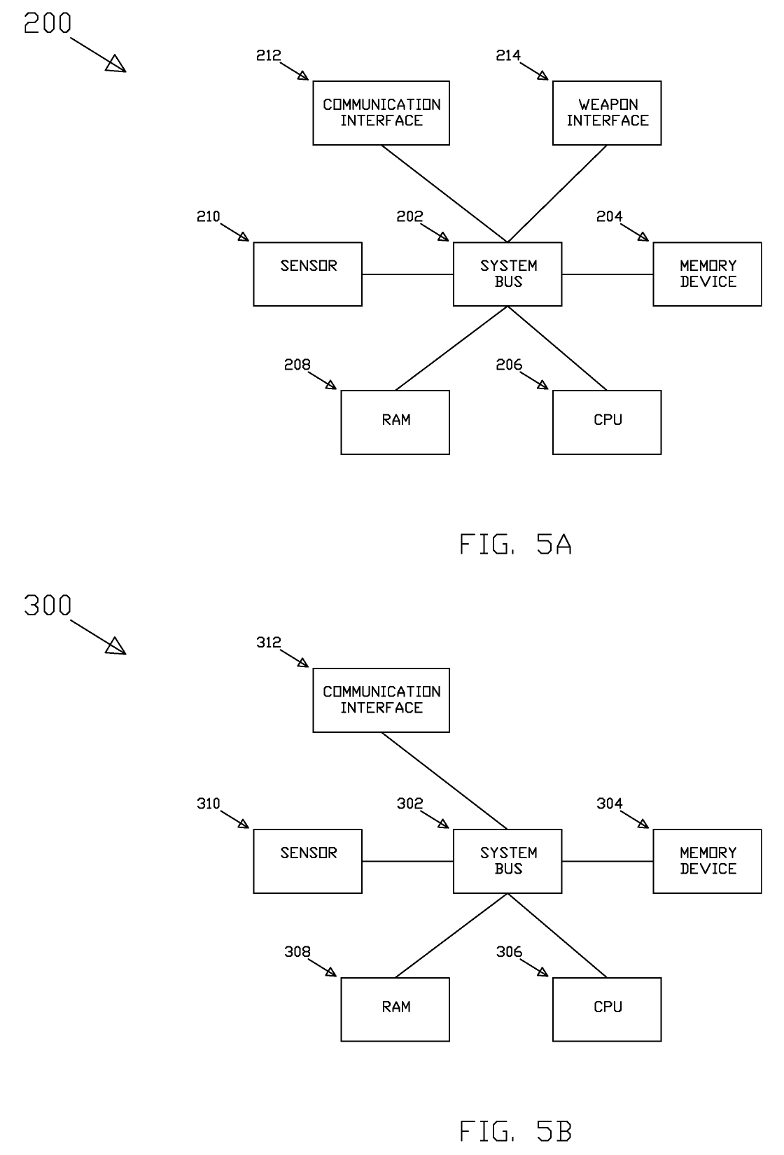

FIGS. 5A and 5B show schematic views of the weapon controller 200 and the enabling device 300, according to examples of the present technology. The weapon controller 200 may include a system bus 202 to coordinate interaction between the remaining components of the weapon controller. A memory device 204 may be provided to store data. A CPU 206 and RAM 208 may be provided for processing functions. A sensor 210, such as a GPS satellite signal receiver, may be provided to detect and/or receive information. Other envisioned sensors 210 include user input devices such as a keypad or a touchscreen to receive user inputs. A communication interface 212 may also be provided to communicate with other devices such as the enabling device. The communication device 212 may facilitate wired or wireless communication in accordance with the examples discussed above. The weapon controller 200 may also include a weapon interface 214 that controls enablement and disablement of the weapon 100.

The enabling device 300 may also include a system bus 302 to coordinate interaction between the remaining components of the enabling device. A memory device 304 may be provided to store data. A CPU 306 and RAM 308 may be provided for processing functions. A sensor 310, such as a GPS satellite signal receiver, may be provided to detect and receive information. Other envisioned sensors 310 include user input devices such as a keypad or a touchscreen to receive user inputs. A communication interface 312 may also be provided to communicate with other devices such as the weapon controller. The communication device 312 may facilitate wired or wireless communication in accordance with the examples discussed above.

In accordance with one example of the technology, the weapon controller 200 may have coordinates stored in the memory device to define an authorized zone of use. When the weapon controller 200 detects that the weapon 100 is located within that authorized zone by receiving GPS location data via the sensor, the weapon interface 214 may enable the weapon. When the weapon controller 200 detects that the weapon's 100 location is outside of the authorized zone of use, the weapon interface 214 disables the weapon.

According to another example, the enabling device 300 may have the coordinates of the zone of authorized use stored in its memory device 304. Thus, the enabling device 300 would need to be in communication with the weapon controller 200 in accordance with examples described above to facilitate enablement of the weapon 100.

Unless the context clearly dictates otherwise and where a range of values is provided, it is understood that each intervening value, to the tenth of the unit of the lower limit, between the upper and lower limit of that range, and any other stated or intervening value in that stated range is encompassed within the technology. The upper and lower limits of these intervening ranges, which may be independently included in the intervening ranges, are also encompassed within the technology, subject to any specifically excluded limit in the stated range. Where the stated range includes one or both of the limits, ranges excluding either or both of those included limits are also included in the technology.

Furthermore, where a value or values are stated herein as being implemented as part of the technology, it is understood that such values may be approximated, unless otherwise stated, and such values may be utilized to any suitable significant digit to the extent that a practical technical implementation may permit or require it.

Unless defined otherwise, all technical and scientific terms used herein have the same meaning as commonly understood by one of ordinary skill in the art to which this technology belongs. Although any methods and materials similar or equivalent to those described herein can also be used in the practice or testing of the present technology, a limited number of the exemplary methods and materials are described herein.

When a particular material is identified as being preferably used to construct a component, obvious alternative materials with similar properties may be used as a substitute. Furthermore, unless specified to the contrary, any and all components herein described are understood to be capable of being manufactured and, as such, may be manufactured together or separately.

It must be noted that as used herein and in the appended claims, the singular forms “a”, “an”, and “the” include their plural equivalents, unless the context clearly dictates otherwise.

All publications mentioned herein are incorporated by reference to disclose and describe the methods and/or materials which are the subject of those publications. The publications discussed herein are provided solely for their disclosure prior to the filing date of the present application. Nothing herein is to be construed as an admission that the present technology is not entitled to antedate such publication by virtue of prior invention. Further, the dates of publication provided may be different from the actual publication dates, which may need to be independently confirmed.

Moreover, in interpreting the disclosure, all terms should be interpreted in the broadest reasonable manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

The subject headings used in the detailed description are included only for the ease of reference of the reader and should not be used to limit the subject matter found throughout the disclosure or the claims. The subject headings should not be used in construing the scope of the claims or the claim limitations.

Although the technology herein has been described with reference to particular examples, it is to be understood that these examples are merely illustrative of the principles and applications of the technology. In some instances, the terminology and symbols may imply specific details that are not required to practice the technology. For example, although the terms “first” and “second” may be used, unless otherwise specified, they are not intended to indicate any order but may be utilised to distinguish between distinct elements. Furthermore, although process steps in the methodologies may be described or illustrated in an order, such an ordering is not required. Those skilled in the art will recognize that such ordering may be modified and/or aspects thereof may be conducted concurrently or even synchronously.

It is therefore to be understood that numerous modifications may be made to the illustrative examples and that other arrangements may be devised without departing from the spirit and scope of the technology.

1. A weapon control system comprising:
a weapon; and
a weapon controller in communication with the weapon,
wherein said weapon controller is configured to receive data and determine whether to enable or disable the weapon.

2. The weapon control system of claim 1, further comprising an enabling device, said enabling device in communication with said weapon controller to provide data to the weapon controller,
wherein said data is used by the weapon controller to determine whether to enable or disable the weapon.

3. The weapon control system of claim 2, wherein said enabling device and said weapon controller are directly connected to one another to facilitate communication.

4. The weapon control system of claim 2, wherein said enabling device and said weapon controller are located separately and are in wired communication.

5. The weapon control system of claim 2, wherein said enabling device and said weapon controller are located separately and are in wireless communication.

6. The weapon control system of claim 1, wherein said weapon controller comprises a sensor and said data comprises location data.

7. The weapon control system of claim 6, wherein said location data is provided by a global positioning satellite to the sensor.

8. The weapon control system of claim 1, wherein said weapon controller comprises a weapon interface to enable and disable the weapon.

9. The weapon control system of claim 1, wherein said weapon controller is integral with said weapon.

10. A method for enabling and disabling a weapon with a weapon controller comprising:
receiving first data through a sensor of the weapon controller;
comparing said first data with second data in a processing unit of the weapon controller, said second data stored in a memory device of the weapon controller;
determining with said processing unit whether to enable or disable the weapon based on comparing said first data with said second data; and
enabling or disabling said weapon with a weapon interface of the weapon controller.

11. The method of claim 10, comprising:
connecting an enabling device to said weapon controller; and
providing third data from said enabling device to said weapon controller,
wherein determining with said processing unit whether to enable or disable the weapon further comprises processing of said third data.

12. The method of claim 10, wherein said first data is location data transmitted by a global positioning satellite and said second data are coordinates defining an authorized zone of use.

13. The method of claim 12, wherein the weapon is enabled when the weapon is determined to be located in the authorized zone of use based on comparing said first data and said second data.
